(19) United States
(12) Patent Application Publication
(10) Pub. No.: US 2013/0156319 A1
(43) Pub. Date: Jun. 20, 2013

(54) FEATURE VECTOR CLASSIFIER AND RECOGNITION DEVICE USING THE SAME

(71) Applicants: Chun-Gi LYUH, Daejeon (KR); Ik Jae CHUN, Daejeon (KR); Jung Hee SUK, Daejeon (KR); Sanghun YOON, Daejeon (KR); Tae Moon ROH, Daejeon (KR)

(72) Inventors: Chun-Gi LYUH, Daejeon (KR); Ik Jae CHUN, Daejeon (KR); Jung Hee SUK, Daejeon (KR); Sanghun YOON, Daejeon (KR); Tae Moon ROH, Daejeon (KR)

(73) Assignee: Electronics and Telecommunications Research Institute, Daejeon (KR)

(21) Appl. No.: 13/550,833

(22) Filed: Jul. 17, 2012

(30) Foreign Application Priority Data
Dec. 14, 2011 (KR) 10-2011-0134351

(51) Int. Cl. G06K 9/46

(52) U.S. Cl. 382/190

(57) ABSTRACT

Provided are a feature vector extractor and a recognition device using the same. The feature vector classifier includes a feature vector extractor configured to generate a feature vector and a normalized value from an input image and output the feature vector and the normalized value; and a feature vector classifier configured to normalize the feature vector based on the normalized value and classify the normalized feature vector to recognize the input image. Thus, during extraction and classification of a feature vector, time required for the extraction and classification and the size of hardware required are significantly reduced.

### CROSS-REFERENCE TO RELATED APPLICATIONS

This US non-provisional patent application claims priority under 35 USC §119 to Korean Patent Application No. 10-2011-0134351, filed on Dec. 14, 2011, the entirety of which is hereby incorporated by reference.

### BACKGROUND OF THE INVENTION

The present general inventive concept relates to feature classifiers and recognition devices using the same.

Image recognition technology is used in a variety of applications such as disease diagnosis, tracking of objects, and autonomous running of robots. Generally, in the image recognition technology, search windows are set to respective regions of an input image signal. Feature vectors are extracted with respect to the set search windows, respectively. A feature vector includes features for use in image recognition. The extracted feature vector is discriminated based on previously learned information, and an image is recognized through the discrimination of the extracted feature vector.

In the image recognition technology, a feature vector extraction operation and a feature vector classification operation are performed on each search window. Accordingly, a large amount of computation is required. As a result, a large amount of hardware resources is required to process high-speed input images in real time.

### SUMMARY OF THE INVENTION

Embodiments of the inventive concept provide a feature vector classifier and a recognition device using the same.

According to an aspect of the inventive concept, the feature vector classifier may include a feature vector extractor configured to generate a feature vector and a normalized value from an input image and output the feature vector and the normalized value; and a feature vector classifier configured to normalize the feature vector based on the normalized value and classify the normalized feature vector to recognize the input image.

In an exemplary embodiment, the feature vector extractor may include a feature extractor configured to extract a feature value from a search window of the input image; and a feature vector generator configured to generate a feature vector having the feature value as an element, compute the normalized value based on the feature value, and output the generated feature vector and the computed normalized value.

In an exemplary embodiment, the feature vector classifier may classify the feature vector using a linear support vector machine (LSVM) algorithm.

In an exemplary embodiment, the feature vector classifier may include a dot-product unit configured to perform dot product of the feature vector and a predetermined weighted vector; and an index classifier configured to classify an index of the feature vector based on a value of the dot product to classify the feature vector.

In an exemplary embodiment, the feature vector may perform dot product with the weighted vector by parallel computing.

In an exemplary embodiment, the dot-product unit may normalize the feature vector based on the normalized value during the dot product of the feature vector and the weighted vector.

According to another aspect of the inventive concept, the feature vector classifier may include a dot-product unit configured to receive a feature vector and a normalized value extracted from an image and normalize the feature vector based on the normalized value; and an index classifier configured to the normalized feature vector depending on an index.

### BRIEF DESCRIPTION OF THE DRAWINGS

The inventive concept will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the inventive concept.

FIG. 1 is a block diagram of a recognition device according to an embodiment of the inventive concept.

FIG. 2 is a detailed block diagram of a feature vector extractor in FIG. 1.

FIG. 3 is a detailed block diagram illustrating an example of the feature vector classifier in FIG. 1.

FIG. 4 is a flowchart illustrating the detailed operation procedure of the embodiment of the feature vector classifier in FIG. 3.

FIG. 5 is a block diagram of an improved recognition device according to an embodiment of the inventive concept.

FIG. 6 is a block diagram illustrating an example of a feature vector classifier in FIG. 5.

FIG. 7 is a flowchart illustrating the detailed operation of the feature vector classifier in FIG. 6.

FIG. 8 is a block diagram illustrating another example of the feature vector classifier in FIG. 5.

FIG. 9 is a flowchart illustrating the detailed operation of the feature vector classifier in FIG. 8.

FIG. 10 is a flowchart illustrating the detailed operation of a feature vector classifier according to another embodiment of the inventive concept.

### DETAILED DESCRIPTION

The inventive concept will now be described more fully hereinafter with reference to the accompanying drawings, in which preferred embodiments of the invention are shown. The inventive concept, however, may be embodied in many different forms and should not be construed as limited to the embodiments set forth herein. Rather, these embodiments are provided so that this disclosure will be thorough and complete, and will fully convey the scope of the invention to those skilled in the art.

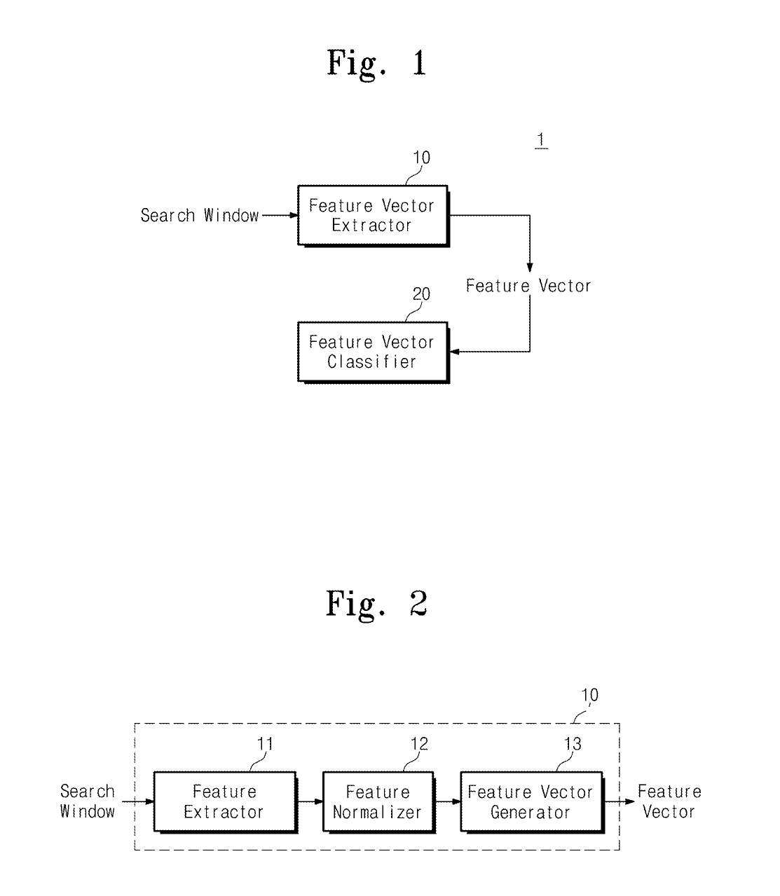

Reference is made to FIG. 1, which is a block diagram of a recognition device 1 according to an embodiment of the inventive concept. The recognition device 1 includes a feature vector extractor 10 and a feature vector classifier 20.

The feature vector extractor 10 generates a feature vector from an input search window. The search window input to the feature vector extractor 10 is a partial image signal corresponding to a specific region of an image signal. A feature vector generated by the feature vector extractor 10 is a vector including features for use in image recognition as an element.

The feature vector classifier 20 classifies an index of a feature vector input from a feature vector extractor. A search window input to the recognition device 1 is classified depending on the classified index of the feature vector. There are various classification algorithms to classify an index of a feature vector. In this embodiment, a linear support vector machine (LSVM) algorithm is used which is one of the most simple classification algorithms. However, this is merely exemplary and the inventive concept is not limited thereto.

In the LSVM algorithm, a feature vector is subjected to a dot-product operation with a predetermined weight vector. An index of a feature vector is determined by a sign of the sum of a value of the dot-product operation and a predetermined offset constant.

Reference is made to FIG. 2, which is a detailed block diagram of the feature vector extractor 10 in FIG. 1. The feature vector extractor 10 includes a feature extractor 11, a feature normalizer 12, and a feature vector generator 13.

The feature extractor 11 extracts a feature value from a search window. The feature value extracted by the feature extractor 11 may be various. For example, the feature value may be a histogram of gradient (HOG) feature, a Harr-like feature, a wavelet feature or a combination thereof. However, this is merely exemplary and the inventive concept is not limited thereto.

Exemplarily, a procedure of generating a feature vector using an HOG feature as a feature value will now be described. HOG describes the orientation of brightness distribution to a local area as a histogram. In order to compute an HOG feature, a search window image is extracted as a block including a plurality of cells. Brightness, gradient orientation, and gradient magnitude of the respective cells constituting the extracted block are computed.

In this embodiment, the gradient orientation is computed through division of zero degree to 180 degrees into nine equal parts with 20 degrees. That is, a single cell has nine orientation histogram bins. Also, in this embodiment, each block includes 2×2 cells. Accordingly, in this embodiment, the number of computed feature values per block, i.e., the number of elements in a feature vector is 36. However, this is merely exemplary and the inventive concept is not limited thereto.

The feature normalizer 12 normalizes feature values extracted by the feature extractor 11. When a feature vector is classified by a feature vector classifier, the environment of a recognized feature vector and the environment of previously learned information do not match each other. For this reason, a normalization procedure is required to prevent distortion of classification result.

The normalization procedure may include various normalization methods. For example, the normalization procedure may be a mean normalization method or a mean and variance normalization (MVN) method. In some embodiments, equation (1) and equation (2) are obtained when applying the mean normalization method that is the simplest normalization method.

$$\begin{matrix}xi = \frac{{xi}^{′}}{N} & Equation ( 1 ) \\ N = {\sum }_{i = 1}^{n} \vert xi \vert + ɛ & Equation ( 2 )\end{matrix}$$

In the equation (1) and equation (2), xi′ represents an i^{th} feature value prior to normalization, xi represents an i^{th} normalized feature value, 1/N represents a normalized value, n represents the total number of elements in a feature vector, and ε represents a constant for preventing computational infinity when the denominator of the equation (1) becomes zero. That is, the normalization procedure using the mean normalization method is a procedure of multiplying a feature value by a reciprocal of the total feature value, i.e., a normalized value.

In other embodiments, the normalization procedure may be a mean square normalization method. Then, a normalized value is computed by equation (3), as follows.

$$N \sqrt{( {\sum }_{i = 1}^{n} {xi}^{2} ) + {ɛ}^{2}} \qquad Equation ( 3 )$$

Similar to the equation (2), in the equation (3), 1/N represents a normalized value, n represents the total number of elements in a feature vector, and ε represents a constant for preventing computational infinity when the denominator of the equation (1) becomes zero. The normalization procedure using the mean square method is also a procedure of multiplying a feature value by a normalized value.

In this case, multiplication to a normalized value for respective n elements constituting a feature vector should be done on the feature vector. Thus, a normalized value computation and n multiplications are required to generate a single feature vector.

The feature vector generator 13 generates a feature vector having a feature value normalized by the feature normalizer 12 as an element. The feature vector generator 13 outputs the generated feature vector.

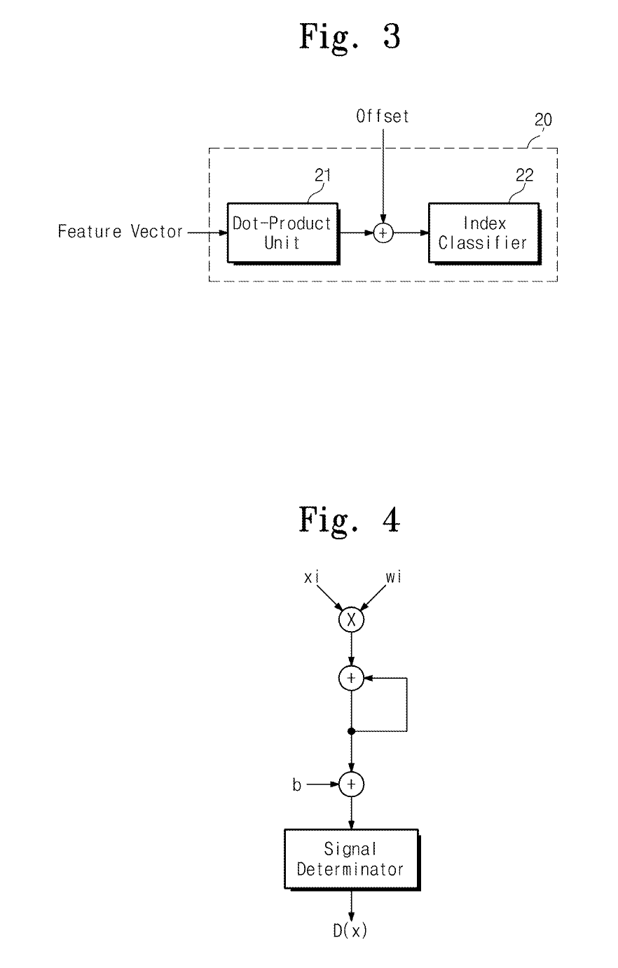

FIG. 3 is a detailed block diagram illustrating an example of the feature vector classifier in FIG. 1. A feature vector classifier 20 includes a dot-product unit 21 and an index classifier 22. The feature vector classifier 20 receives a feature vector and an offset.

The dot-product unit 21 performs a dot-product operation on a feature vector and a weight vector that are input from the feature extractor 10. The weight vector is a vector having a weight on a feature value as an element and has the same number of elements as the feature vector. A dot-product result value output from the dot-product unit 21 is added to an offset b to be transferred to the index classifier 22.

The index classifier 22 classifies an index of a feature vector, based on the input addition result value. For example, the index classifier 22 may classify an index of a feature vector by computing a sign of the input addition result value. In this case, the feature vector is classified into two types. However, this is merely exemplary and the inventive concept is not limited thereto. The index classifier 22 classifies a search window image input to a recognition device, based on the classification result of the feature vector.

Reference is made to FIG. 4, which is a flowchart illustrating the detailed operation procedure of the embodiment of the feature vector classifier 20 in FIG. 3. Let it be assumed that a feature vector X has n feature values x1, x2, . . . , and xn. Also let it be assumed that a weight vector W has n weights w1, w2, . . . , and wn.

In FIG. 4, an i^{th} feature value xi is multiplied by an i^{th} weight wi. The multiplied value is cumulatively added until the n^{th} feature value is weighted. When the n^{th} weighted feature value is added (x1w1+x2w2+ . . . +xnwn), a computed result is input to a sign determinator after being added to the offset b. The sign determinator determines a sign of the input value to output a result of the determination to a binary bit D(x).

Accordingly, the recognition device in FIGS. 1 to 4 extracts a normalized feature vector from a search window and classifies an index of the extracted feature vector to classify an input search window. However, an operation of multiplying a feature value by a normalized value is required during normalization of a feature vector. Since multiplication cannot be done before computation of the normalized value, a normalization procedure should be started after all feature values are obtained. Thus, parallel operation cannot be performed and long time is required for performing the operation.

Reference is made to FIG. 5, which is a block diagram of an improved recognition device 100 according to an embodiment of the inventive concept. The recognition device 100 includes a feature vector extractor 110 and a feature vector classifier 120. The feature vector extractor 110 includes a feature extractor 111 and a feature vector generator 112.

The feature vector extractor 110 generates a feature vector from an input search window. Unlike the feature vector extractor 10 in FIG. 1, the feature vector extractor 110 outputs a non-normalized feature vector and a normalized value.

The feature extractor 111 extracts a feature value from the input search window. The feature value extracted by the feature extractor 111 may be various. For example, the feature value may be a histogram of gradient (HOG) feature, a Harr-like feature, a wavelet feature or a combination thereof. However, this is merely exemplary and the inventive concept is not limited thereto.

The feature vector generator 112 generates a feature vector having a feature value extracted by the feature extractor 111 as an element. In addition, the feature vector generator 112 computes a normalized value from the feature value. The normalized value may be computed by various methods. For example, the normalized value may be computed by a mean normalization method or a mean and variance normalization (MVN) method. The feature vector generator 112 outputs the generated feature vector and the computed normalized value.

In the feature vector extractor according to this embodiment, an operation of multiplying the normalized value is not performed. Thus, a size of hardware and computation performing time are reduced.

The feature vector classifier 120 determines a feature vector, based on the feature vector and the normalized value that are input from the feature vector extractor 110. Hereinafter, the operation of a feature vector classifier will now be described below.

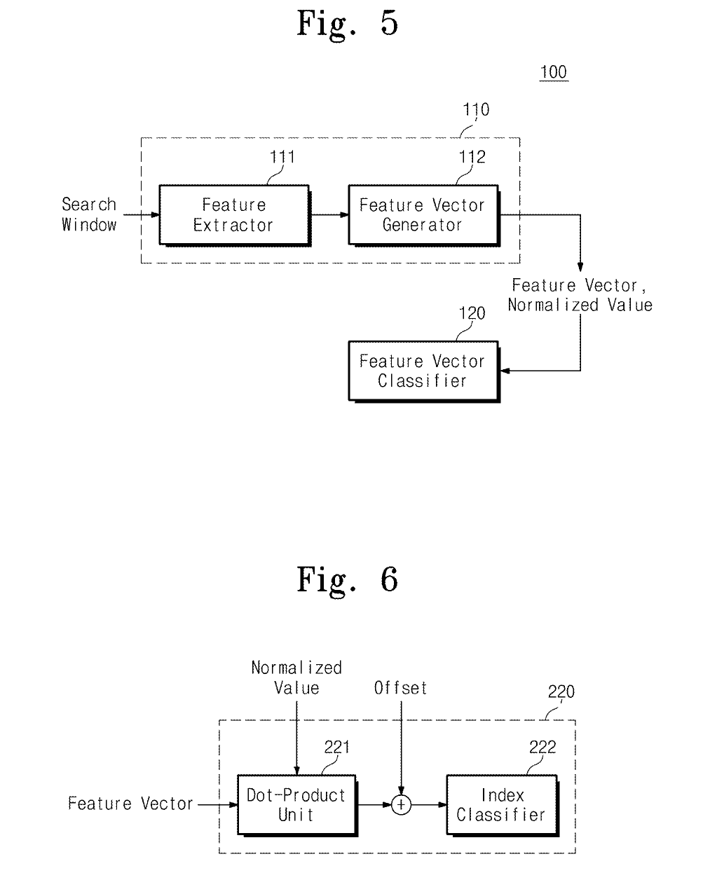

Reference is made to FIG. 6, which is a block diagram illustrating an example of the feature vector classifier 220 in FIG. 5. The feature vector classifier 220 includes a dot-product unit 221 and an index classifier 222.

The dot-product unit 221 receives a feature vector and a normalized value. The dot-product unit 221 does multiplication to multiply the normalized value while doing multiplication for dot product of the feature vector and a weighted vector. A result value computed by the dot-product unit 221 is transferred to the index classifier 222 after being added to an offset.

The index classifier 222 classifies an index of the feature vector, based on the input addition result value. For example, the index classifier 222 may classify an index of the feature vector by computing a sign of the input addition result value. In this case, the feature vector is classified into two types. However, this is merely exemplary and the inventive concept is not limited thereto. The index classifier 222 classifies a search window image input to a recognition device, based on the classification result of the feature vector.

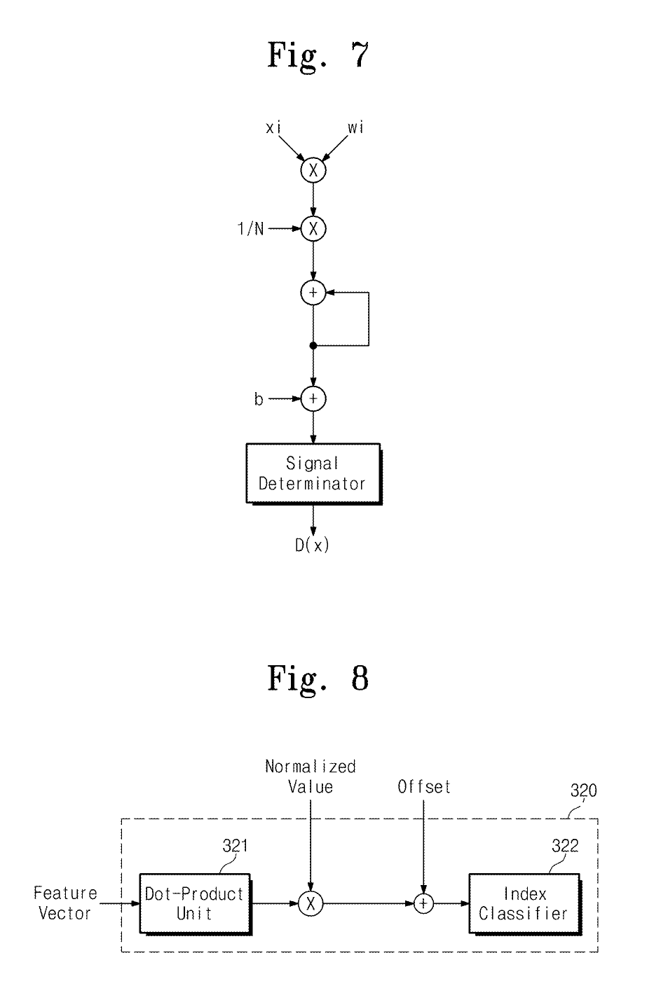

Reference is made to FIG. 7, which is a flowchart illustrating the detailed operation of the feature vector classifier 220 in FIG. 6. Let it be assumed that a feature vector X has n feature values x1, x2, . . . , and xn. Also let it be assumed that a weight vector W has n weights w1, w2, . . . , and wn.

In FIG. 7, an i^{th} feature value xi is multiplied by an i^{th} weight wi. The multiplied value is re-multiplied by a normalized value 1/N. The re-multiplied value is cumulatively added until the n^{th} feature value is weighted. When the n^{th} normalized weighted feature value is added (x1w1/N+x2w2/N+ . . . +xnwn/N), a computed result is input to a sign determinator after being added to an offset b. The sign determinator determines a sign of the input value to output a result of the determination to a binary bit D(x).

Accordingly, in the recognition devices in FIGS. 5 to 7, a feature vector classifier receives a feature vector and a normalized value to normalize the received feature value and determines the feature vector based on the normalized feature value. Multiplication of the normalized value by the feature vector classifier is done n times (n being the number of elements in the feature vector). Thus, there is no gain in the number of operations and size of hardware, as compared to the case where a normalization procedure is performed in the recognition device in FIG. 1. Nonetheless, unlike the recognition in FIG. 1 which is not capable of performing parallel computing, the recognition device according to this embodiment may perform some of a classification operation, before computation of a normalized value, as a normalization procedure is performed with delay.

Reference is made to FIG. 8, which is a block diagram illustrating another example of the feature vector classifier in FIG. 5. A feature vector classifier 320 includes a dot-product unit 321 and an index classifier 322.

The dot-product unit 321 receives a feature vector and a normalized value. The dot-product unit 321 performs an addition operation for dot product of the feature vector and a weighted vector. A dot-product result value obtained by the dot-product unit 321 is transferred to the index classifier 322 after being multiplied by the normalized value and added to an offset.

The index classifier 322 classifies an index of the feature vector, based on the input addition result value. For example, the index classifier 322 may classify an index of the feature vector by computing a sign of the input addition result value. In this case, the feature vector is classified into two types. However, this is merely exemplary and the inventive concept is not limited thereto. The index classifier 322 classifies a search window image input to a recognition device, based on a classification result of the feature vector.

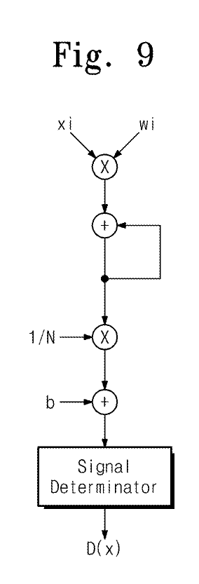

FIG. 9 is a flowchart illustrating the detailed operation of the feature vector classifier 320 in FIG. 8. Let it be assumed that a feature vector X has n feature values x1, x2, . . . , and xn. Also let it be assumed that a weight vector W has n weights w1, w2, . . . , and wn.

In FIG. 9, an i^{th} feature value xi is multiplied by an i^{th} weight wi. The multiplied value is cumulatively added until the n^{th} feature value is weighted. When the n^{th} weighted feature value is added (x1w1+x2w2+ . . . +xnwn), a computed result is re-multiplied by a normalized value 1/N. The re-multiplied value is input to a sign determinator after being added to an offset b. The sign determinator determines a sign of the input value to output a result of the determination to a binary bit D(x).

Accordingly, in the recognition devices in FIGS. 5 to 9, a feature vector classifier receives a feature vector and a normalized value. The feature vector classifier multiplies an input feature value by a weight and normalizes the multiplied value. The feature vector classifier determines the feature vector, based on the normalize feature value.

In the feature vector classifier, multiplication of a normalized value is done only once. Therefore, the number of operations and the size of hardware are reduced as compared to the case where a normalization procedure is performed in the recognition device in FIG. 1. Unlike the recognition in FIG. 1 which is not capable of performing parallel computing, the recognition device according to this embodiment may perform some of a classification operation, before computation of a normalized value, as a normalization procedure is performed with delay. That is, even a dot-product operation of a feature vector and a weighted vector may be performed before computation of a normalized value. Thus, time required for the computation may be further reduced.

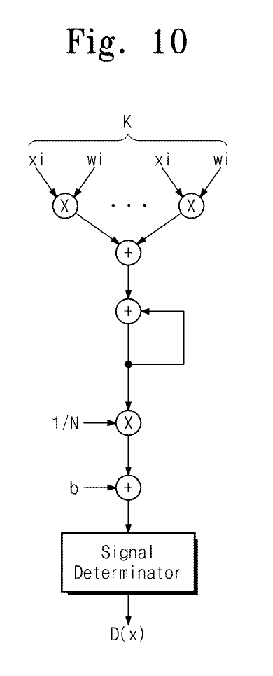

Reference is made to FIG. 10, which is a flowchart illustrating the detailed operation of a feature vector classifier according to another embodiment of the inventive concept. Unlike the feature vector classifier 320 in FIG. 9, the feature vector classifier in FIG. 10 is further provided with an additional hardware resource to perform parallel computing. Referring to FIG. 10, in a feature vector classifier, k feature values are simultaneously multiplied in parallel when a dot-product operation is performed. If weights are multiplied in parallel according to the time a normalized value is computed, time required for performing computation is significantly reduced. Although additional hardware is required to perform parallel computing, extremely large hardware is not required in this embodiment because the size of hardware is reduced as a normalization procedure is performed with delay.

According to a feature vector classifier and a recognition device using the same described above, during extraction and classification of a feature vector, time required for the extraction and classification and the size of hardware required are significantly reduced.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A recognition device comprising:
a feature vector extractor configured to generate a feature vector and a normalized value from an input image and output the feature vector and the normalized value; and
a feature vector classifier configured to normalize the feature vector based on the normalized value and classify the normalized feature vector to recognize the input image.

2. The recognition device as set forth in claim 1, wherein the feature vector extractor comprises:
a feature extractor configured to extract a feature value from a search window of the input image; and
a feature vector generator configured to generate a feature vector having the feature value as an element, compute the normalized value based on the feature value, and output the generated feature vector and the computed normalized value.

3. The recognition device as set forth in claim 1, wherein the feature vector classifier classifies the feature vector using a linear support vector machine (LSVM) algorithm.

4. The recognition device as set forth in claim 3, wherein the feature vector classifier comprises:
a dot-product unit configured to perform dot product of the feature vector and a predetermined weighted vector; and
an index classifier configured to classify an index of the feature vector based on a value of the dot product to classify the feature vector.

5. The recognition device as set forth in claim 4, wherein the feature vector performs dot product with the weighted vector by parallel computing.

6. The recognition device as set forth in claim 4, wherein the dot-product unit normalizes the feature vector based on the normalized value during the dot product of the feature vector and the weighted vector.

7. The recognition device as set forth in claim 4, wherein the index classifier normalizes a dot-product value output from the dot-product unit based on the normalized value and classifies an index of a feature vector based on the normalized dot-product value.

8. A feature vector classifier comprising:
a dot-product unit configured to receive a feature vector and a normalized value extracted from an image and normalize the feature vector based on the normalized value; and
an index classifier configured to the normalized feature vector depending on an index.

9. The feature vector classifier as set forth in claim 8, wherein the feature vector has a histogram of gradient (HOG) feature value as an element.

10. The feature vector classifier as set forth in claim 8, wherein the normalized value is computed by a mean normalization method.

11. The feature vector classifier as set forth in claim 8, wherein the normalized value is computed by a mean square normalization method.
